(19) United States
(12) Patent Application Publication
(10) Pub. No.: US 2026/0273879 A1
(43) Pub. Date: Sep. 17, 2026

(54) METHOD AND APPARATUS FOR MANUFACTURING AN OPTICAL ELEMENT, OPTICAL ELEMENT AND OPTICAL SYSTEM

(71) Applicant: Optotune Switzerland AG, Dietikon (CH)

(72) Inventors: David Andreas NIEDERER, Dietikon (CH); Manuel Aschwanden, Dietikon (CH); Stephan SMOLKA, Dietikon (CH)

(73) Assignee: Optotune Switzerland AG, Dietikon (CH)

(21) Appl. No.: 19/472,667

(22) PCT Filed: Apr. 5, 2024
(86) PCT No.: PCT/EP2024/059293

§ 371 Date: Oct. 5, 2025

(30) Foreign Application Priority Data
Apr. 5, 2023 (DE) 10 2023 108 692.8

(51) Int. Cl. B29D 11/00

(52) U.S. Cl. CPC B29D 11/00557; B29D 11/00442; B29D 11/00548

(57) ABSTRACT

The invention relates to a method for optically modifying an optical component comprising: A) Arranging a liquid material (5) in a cavity (100) with a first surface portion (101) and a second surface portion (102), wherein the first surface portion (101) of the cavity (100) is formed by a first deformable membrane (2); B) Adjusting a shape of the first membrane (2) such that an optical power of the optical element (12) to be manufactured is adjusted; C) Solidifying the liquid material (5) to obtain the optical element (12) with a first surface (12-1) that conforms to the first surface portion (101) of the cavity (100) and a second surface (12-2) that conforms to the second surface portion (102) of the cavity (100), wherein the optical element (12) comprises an optical power adjusted by the shape of the first and the second surface (12-1, 12-2). D) Attaching the optical element (12) to an optical surface (20-1) of the optical component (20), wherein the first surface (12-1) of the optical element (12) faces the optical surface (20-1) of the optical component (20).

The invention relates to a method for optically modifying an optical component with an optical element, as well as to an optical system comprising an optical element.

Optical elements can be used in optical devices and systems to influence a light beam, for example by deflection, refraction or focus. In particular, this makes it possible to correct imaging aberrations.

Typically, optical elements are produced by means of complex manufacturing processes, wherein desired optical properties are set according the individual application of the optical element. However, these manufacturing processes are time-consuming and cost-intensive. Furthermore, it is disadvantageous that optical devices, which comprise optical elements, have optical properties that can only be changed by disassembling the device and replacing the optical element.

It is an objective of the invention to provide a method and means by which an optical element can be manufactured inexpensively and with a high degree of flexibility with regard to the adjustability of the optical properties of the optical element, wherein the optical element is to be attached to an optical component, that is to be adjusted in terms of its optical properties.

The objective is solved by means of a method according to claim 1, and an optical system according to claim 15. Advantageous further embodiments are subject of dependent claims.

According to a first aspect of the invention, a method for optically modifying an optical component, such as a lens, glasses and/or googles, with an optical element, comprises at least the following steps:
A) Arranging a transparent, solidifiable, particularly curable, liquid material, such as a polymer, in a cavity, wherein the cavity comprises a first surface portion, particularly a first smooth surface portion, and a second surface portion, particularly a second smooth surface portion, wherein the first surface portion of the cavity is formed by a first deformable membrane;
B) Adjusting a shape of the first membrane, such as to adjust a shape of the first surface portion of the cavity, such that an optical power of the optical element to be manufactured is adjusted;
C) Solidifying, particularly curing, the liquid material to obtain the optical element, wherein the optical element comprises a first surface that conforms to the first surface portion of the cavity and a second surface that conforms to the second surface portion of the cavity, wherein the optical element comprises an optical power adjusted by the shape of the first and the second surface.
D) Attaching the optical element to an optical surface, particularly a smooth optical surface of the optical component, wherein the first or the second surface of the optical element faces, particularly contacts the optical surface of the optical component, such that the optical component is optically modified by the optical power of the optical element.

The invention is based on the realization that solidifiable, particularly curable liquids or liquid materials can be used to manufacture optical elements with individually adjustable optical properties. The liquid material may in particular be a transparent, curable liquid polymer. Such a polymer is typically easy to handle and has good forming properties, which makes it particularly suitable for the manufacture of optical elements.

The cavity may have one or more openings, particularly wherein the cavity may be formed by a recess or a circumferentially open volume limited by the first and the second surface portion.

According to the invention, the solidifiable liquid material is provided to a cavity at least partially formed by at least a first deformable membrane. The invention is not limited to a specific embodiment of the membrane. It is only required that said membrane is deformable e.g. by an external force and at the same time that the membrane exhibits a sufficiently high tensile strength e.g. for maintaining a desired shape. In a simple embodiment, the first membrane may be made of a thin film, in particular a thin polymer film.

By providing the solidifiable liquid material to the first membrane and then adjusting the shape of said membrane, the liquid material adapts to the shape of the surface portion of the membrane due to its liquid aggregate state. By solidifying the liquid material, the optical element is obtained and the shape, particularly the shape of the first surface of the optical element is set according to the shape of the surface portion of the membrane.

In other words, the membrane partially forms a selectively controllable deformable mould by means of which the optical element can be produced with an individually adjustable shape. Investigations have shown that by means of the method according to the invention it is possible to manufacture the optical element at least partially with any kind of geometry, preferably however with a cylindrical or spherical geometry. Since the optical properties of the optical element depend of its shape, the deformation of the first membrane directly allows to set the optical properties of the optical element. In particular, the optical element is at least transparent for visible light and is configured to be used in optical devices.

The invention is not limited to a specific sequence, according to which the process steps A) and B), are to be carried out. For example, the liquid material can first be dispensed to the first membrane and subsequently the first membrane may be deformed or vice versa.

According to another embodiment of the invention, the second surface portion may be formed by the optical surface of the optical component. This allows for an integrated process that in essence combines steps C) and D).

According to another embodiment of the invention, a circumferential shape and size of the optical element is identical to a circumferential shape and size of the optical surface of the optical component, such that the optical element and the optical surface may be arranged flush with respect to each other.

This embodiment allows for an appealing and unobtrusive design.

According to another embodiment of the invention, the second surface portion is formed by a second deformable membrane, and wherein a shape of the second membrane is adjusted in step B), such as to adjust a shape of the second surface portion of the cavity

Particularly, the features and definitions provided in the context of the first membrane are applicable to the second membrane in an analogous fashion.

The specific sequence, according to which the first and the second membrane shapes adjusted may be selectable. The shape of the membranes may be adjusted simultaneously or sequentially.

The second membrane can be positioned in such a way that the liquid material is arranged, particularly enclosed, between the first and the second membrane and is then solidified. Alternatively, it is within the scope of the invention that none of the membranes is deformed, i.e. adjusted with respect to its shape, until the liquid material is enclosed between the membranes.

For the embodiment described above, the liquid material, in particular a liquid polymer, can be brought between the first and the second membrane so that the membranes form a pressure-tight space in which the polymer is located. If one of the membranes is deformed, the deformation leads to a pressure increase in the liquid polymer and to a deformation of the other membrane. The membranes are thus deformed essentially simultaneously.

The invention is not limited to the manner, according to which a pressure-tight space is formed. In a simple embodiment, however, the membranes can be in circumferential contact with each other in their respective edge regions and thereby form a chamber in which the polymer is located. Alternatively, the membranes may be connected indirectly via a ring like spacer element that encloses the liquid material in lateral direction and by the membranes in axial direction. It is also within the scope of the invention that the membranes are each held by dies, which are movable in such a way as to allow easy application of the polymer between the membranes in an open state and are movable into a closed state, in which the polymer is enclosed by the membranes and the dies.

According to another embodiment of the invention, between step C) and D) the optical element is removed from, particularly separated from the second and/or the first surface portions of the cavity.

This allows for reusing the first and/or the second membranes.

According to another embodiment of the invention, the first and/or the second membrane remain attached to the optical element, when the optical element is attached to the optical component.

This embodiment allows for a particularly simple method, that may use properties of the membrane(s) for the optical component or the attachment thereto. For example, the membrane(s) may provide an additional scratch-protective, or anti-reflection layer. The latter may be achieved by selecting appropriate membrane materials or by coating the membrane(s) with a corresponding material.

According to another embodiment of the invention, the first membrane and/or the second membrane is at least partially transparent for ultraviolet radiation, and wherein the liquid material is an ultraviolet curing liquid polymer, and wherein method step C) comprises an exposure of the liquid polymer to ultraviolet radiation through the first and/or the second membrane.

This embodiment allows using optical curing while maintaining transparency in the visible spectral region, i.e. at wavelength longer than 380 nm.

Particularly, the term “ultraviolet” refers to a wavelength range from 200 nm to 380 nm.

The use of transparent membranes and for example an ultraviolet (UV) curable polymer is advantageous because the required ultraviolet radiation can be provided from outside the membranes, in particular such that no further means are required to cause the curing of the polymer. Preferably, one or more ultraviolet radiation sources are arranged on a side of the first and/or the second membrane that face away from the liquid polymer.

According to an embodiment of the invention, the first membrane and/or the second membrane is at least partially transparent for infrared radiation, and wherein the liquid material is an infrared curing liquid polymer, and wherein method step C) comprises an exposure of the liquid polymer to infrared radiation through the first and/or the second membrane.

This embodiment allows using optical curing while maintaining transparency in the visible spectral region, i.e. at wavelength shorter than 750 nm.

The use of transparent membranes and for example an infrared (IR) curable polymer is advantageous because the required infrared radiation can be provided from outside the membranes, in particular such that no further means are required to cause the curing of the polymer. Preferably, one or more infrared radiation sources are arranged on a side of the first and/or the second membrane that face away from the liquid polymer.

Particularly, the term “infrared” refers to a wavelength range from 750 nm to 1.500 nm.

According to another embodiment of the invention, the liquid material is liquid at a first temperature and a first pressure, wherein the liquid is filled into the cavity at said first temperature and pressure, wherein in method step C) for solidification the liquid is cooled to a second temperature, particularly wherein the first pressure is essentially maintained, particularly wherein the second temperature is lower than the first temperature, wherein the liquid polymer solidifies due to the lower second temperature.

This embodiment allows using thermal curing, such that no additional optical light sources are required to form the optical element.

Particularly, the second temperature is lower than 60 C, more particularly lower than 45 C. Particularly, the second temperature is higher than 15 C. The first temperature may be higher than 60 C.

According to another embodiment of the invention, the liquid material comprises a first component and a second component that a are configured to commence a curing process the moment they contact each other or are mixed with each other, such that the liquid material cures by way of the two-component curing components.

The two components may be mixed shortly before providing the liquid material to the cavity or may be provided subsequently, or simultaneously to the cavity.

This embodiment allows for curing processes without the need of an external light source.

According to another embodiment of the invention, the second surface of the optical element is attached to the surface of the optical surface of the component by means of Van der Waals forces, particularly only by means of van der Waals forces.

This embodiment allows for attaching the optical element to the optical component without any additional adhesive, which renders the application of the optical element to the optical component particularly easy.

The second surface of the optical element as well as the optical surface of the optical component may be configured to exhibit the necessary properties to allow Van Der Walls forces to be high enough to achieve this effect. The skilled person is aware of ways to achieve this or which materials may be suitable, particularly with regard to a selection of the material for the optical element.

According to another embodiment of the invention, the optical element, particularly the first and/or the second surface of the optical element is shaped such that either alone or in combination with the optical component one or more optical parameters selected from the group consisting of cylinder, astigmatism, coma, prism or a higher order Zernike polynomial aberration are adjusted, particularly to adjust a person's vision deficit.

This embodiment allows for a method that is capable of retrofitting or upgrading an optical component, to specific vision deficits of a person wearing the optical component.

According to another embodiment of the invention, the shape of the first membrane and/or the shape of the second membrane is adjusted by a mechanical element, wherein the mechanical element is configured to adjust the shape of the first and/or the second membrane such as to yield the optical element exhibiting the one or more optical parameters, particularly wherein the mechanical element is a lens shaper device.

The mechanical element can be a structural component by means of which it is possible to exert a force to one of the membranes in a punctiform, linear or planar region. Preferably, multiple mechanical element can be provided to exert a force on the first and/or the second membranes. In particular, by using the mechanical elements, it is possible to apply a pushing force or a pulling force to one of the membranes. To exert the pulling force, the mechanical element can be attached to the first or the second membrane by means of an adhesive. Preferably, the adhesive is soluble, such that the mechanical element can be detached from the membrane(s). However, it is also within the scope of the invention, that the first and/or the second membrane can be detached from the optical element after curing and be disposed.

Preferably, the deformation of the membrane(s) is controlled by a control unit, designed to operate a closed control loop, in particular such that the deformation of the second membrane is performed as a function of the hydraulic pressure of the liquid material and/or of the deformation of the first membrane and/or the movement and/or force of the mechanical elements.

According to another embodiment of the invention, the shape of the first membrane is formed by the mechanical element, and wherein the shape of the second membrane is formed as a function of a hydraulic pressure of the liquid material or vice versa.

This embodiment allows for a directly controlled method to produce the optical element to increase the positioning accuracy of the first membrane.

According to another embodiment of the invention, the shape of the first membrane and/or the shape of the second membrane is adjusted by a fluidic pressure that is applied to a surface of the first and/or second membrane that faces away from the liquid material.

In this embodiment, the pressure of a fluid, preferably air pressure or a fluid pressure can be used to cause a desired deformation of the first and/or the second membrane. In particular, different pressures can be set to the two membranes, particularly to the sides of the membrane(s) facing away from the liquid material.

In an alternative embodiment, method step B) comprises a successive deformation of the first membrane and the second membrane.

The invention is not limited to a simultaneous deformation of the membranes. Rather, the deformation of the membranes may also take place one after the other. In a preferred embodiment, in method step A) the liquid material is first applied to the first membrane such that the first membrane deforms as a result of a force exerted by the application of the liquid material, in particular as a result of a force of weight of the liquid material. The second membrane is brought in contact with the liquid material and deforms as a result of an adhesive force of the liquid material, preferably the curable, liquid polymer.

It is an advantage of the embodiment described above that, in principle, no additional deformation means are required to cause deformation of the first and/or the second membrane. Rather, the membranes can be designed to be flexible to a degree that a small amount of curable, liquid material leads to a deformation of the first membrane due to its weight. If the second membrane is then brought into contact with the material, the second membrane is drawn towards the first membrane as a result of adhesion to the liquid material and is thus deformed. This effect is in particular achievable, if the liquid material is an ultraviolet curable polymer.

According to another embodiment of the invention, the shapes of the first and the second membrane are formed by successive deformation of the first membrane and the second membrane.

According to another embodiment of the invention, the liquid material is applied to the first membrane or the second membrane such that the shape of the respective membrane is formed as a result of a force exerted by the application of the liquid material, in particular as a result of a force of weight of the liquid material on the respective membrane, and wherein the respective other membrane (of the first and the second membrane) is brought in contact with the liquid material, wherein the shape of the respective other membrane is formed as a result of an adhesive force of the liquid material.

According to another embodiment of the invention, a solidification, particularly a curing process of the liquid material is controlled such that the solidified particularly cured optical element is flexible, particularly wherein the solidification is terminated before the liquid material is solidified to a solid state.

According to another embodiment of the invention, the liquid material comprises a duroplast, an elastomere and/or a thermoplast.

The above-described further embodiment is based on the realization that it is not necessary to allow the liquid material, particularly UV-curable polymer, to fully cure in order to obtain an optical element with the desired optical properties. Rather, the curing process can be terminated when the liquid material has partly solidified as a result of curing, but has not yet fully cured and thus has a good elastic deformability. This makes it possible to subsequently apply the optical element to curved optical surfaces. This can be done in a simple way by controlling the radiation duration and/or radiation intensity, on which the degree of cure depends.

According to another embodiment of the invention, the optical component is selected from the group consisting of a rigid lens, ski goggles, scuba diver googles, safety goggles, eyeglasses, sunglasses, virtual reality, augmented glasses, a wave-guide structure, a wave-guide diffractive structure, a wave-guide refractive structure.

This embodiment provides particularly useful application of the method, as it allows to adjust optical components that are typical on a consumer level.

In a preferred embodiment, the optical element is processed after its withdrawal between the membranes by means of a cutting step, in particular in an edge region. In this context, the edge region is to be understood as a circumferential area that surrounds the edge of the optical element with respect to an optical axis.

In a further embodiment, the optical element is provided with a mark during or after the execution of one of the process steps A), B), C), D). Such a mark can be used to identify the optical element to easily distinguish its optical surfaces from each other or, for example, to simplify the positioning of the optical element on another optical component by orienting the optical element depending on the position of the mark.

Particularly, the optical element may be attached to the optical component like a sticker with an adhesive surface.

According to a second aspect of the invention, an optical system is disclosed that comprises a transparent optical element having an optical power, wherein the optical element comprises a material, particularly a polymer, with a first surface, particularly a first smooth surface and second surface, particularly a second smooth surface facing in the opposite direction of the first surface, wherein the optical element is flexible and bendable such that the first surface may be bent to conform to a curved surface, particularly a smooth curved surface, wherein the first surface is configured such that when the first surface is brought in extensive contact with a complementary surface, particularly wherein the complementary surface comprises or consists of a polymer, a synthetic polymer or a glass, Van der Waals forces, particularly only van der Waals forces between the first surface and the complementary surface cause the optical element to be attached, particularly permanently attached to the complementary surface, wherein the optical element is shaped such that either alone or in combination with the optical component one or more optical parameters selected from the group consisting of cylinder, astigmatism, coma, prism or a higher order Zernike polynomial aberration are adjusted, particularly to adjust a person's vision deficit.

The system according to the second aspect of the invention, allows for retrofitted optical components that comprise an optical element that adjusts an optical power or optical parameter for example to a person vision deficit. This allows for manufacturing optical components such as sunglasses, googles or VR/AR googles without specific optical properties regarding optical power or aberrations that are retrofitted with the optical element that provides or adjusts a pre-existing optical power of the optical component.

The term “flexible and bendable” particularly refers to a shore durometer that is considered to describe a flexible and bendable material, particularly directly after manufacture. Particularly, the shore durometer may be may lower than 80 D, particularly lower than 60 D, more particularly lower than 50 A.

The optical element may consist at least partly of a curable component, in particular a transparent, curable liquid polymer, and comprises a first surface, which is designed for attaching the optical element to an optical surface of an optical component.

An advantage associated with the optical element according to the invention is that the optical element can be used in a simple manner to form the optical system whose optical properties can be individually adjusted by application to an optical component. This is an advantage in particular for any kind of rigid lens as well as ski goggles, scuba diver googles, safety goggles, eyeglasses, sunglasses, virtual reality glasses.

According to another embodiment of the invention, a circumferential shape and size of the optical element is identical to a circumferential shape and size of the optical surface of the optical component. This embodiment allows for a flush design of the optical system, which reduces reflections at the edges of the optical element and optical component and provides a visually appealing and unobtrusive system.

According to another embodiment of the invention, the second surface is concave or convex, particularly wherein the second surface is coated by an antireflection coating.

This allows for adjusting the optical properties of the optical system to a greater extend. Further, the anti-reflection coating may be advantageous to suppress unwanted reflections in or at the optical system.

Preferably, the optical element is coated by an antireflection coating and/or has an anti-reflection treated surface on a side facing away from the optical surface of the optical component. This improves the optical properties of the optical element for use on a wearable optical component.

According to another embodiment of the invention, the optical system comprises an optical component with an optical surface that comprises the complementary surface, wherein the optical element is attached via its first surface to the optical surface of the optical component by means of Van der Waals forces.

This embodiment teaches the advantageous combination of the optical element with an optical component that may be retrofitted or adjusted by means of the optical element.

The optical component may or may not comprise an optical power or an aberration that may be corrected by the optical element.

According to another embodiment of the invention, an adhesive is arranged on the first surface of the optical element, such that when the optical element is attached to the optical component's optical surface, the optical element is glued to the optical component.

This embedment is supplementing the adhesive forces exerted by the Van-der Waals forces between the first surface and the optical surface of the optical component. The obtained system is more robust and the optical element may be permanently fixed at a fixed location on the optical component.

According to another embodiment of the invention, the optical component is selected from the group consisting of: googles, glasses, VR-googles, wherein the optical surface faces towards a person's eyes, when the person wears the optical component.

An adjusting the optical power and the aberrations of an optical component selected from this group allows to adjust optical components that are manufactured regardless of a person's vision deficits.

According to another embodiment of the invention, the optical component comprises two optical surface portions comprised by the optical surface, wherein the surface portions are arranged such that a person wearing the optical component has one of the surface portions arranged in front of the person's eye, wherein on each optical surface portion an optical element is attached.

This embodiment in essence describes googles that may be equipped with two optical elements that adjust the optical properties of the optical component individually for each eye.

This embodiment allows for each eye to adjust the optics according to a person's vision deficits on each eye. For this purpose, the two optical elements may exhibit different optical parameters and/or optical powers.

The optical surface portions may be the glasses of the googles.

According to another embodiment of the invention, a circumferential shape and size of each optical element is identical to a circumferential shape and size of the optical surface portion of the optical component.

This embodiment allows for a flush design of the optical system, which reduces reflections at the edges of the optical element and optical component and provides a visually appealing and unobtrusive system.

According to another embodiment of the invention, the optical power of each optical element is selected such that an optical power of the optical component is adjusted, particularly wherein the optical power of each optical element is different, particularly wherein the optical component does not exhibit an optical power.

This embodiment specifies advantageous properties of the optical system, in which each optical element may exhibit different optical properties.

According to another embodiment of the invention, each optical element is shaped as thin lens, that is adapted to conform with the first surface of the optical element the to the optical surface of the optical component.

This embodiment allows for a discrete modification of the optical component. The thin lens may be in essence a sticker-like optical element, that is attached to the optical component and alters the optical properties with regard to optical power and aberrations in a defined fashion.

Particularly, the optical power adjustment may be greater than 0.5 dioptre or smaller than-0.5 dioptre.

According to another embodiment of the invention, a width of each optical element is at least 5 to 20 times greater, particularly 10 times to 20 times greater, than a thickness of the optical element.

A thin lens may be summarized under these geometric properties of the topical element.

Such thin optical element with an optical power and correcting an aberration are difficult to manufacture. The method according to the invention allows to manufacture such thin optical elements with defined properties.

Particularly, each optical element comprises a main extension plane and an optical axis oriented orthogonally to the main extension plane, wherein a ratio of an axial extension of the optical element along the optical axis and a lateral extension of the optical element in the main extension plane is less than 1/5, preferably less than 1/10.

With the aforementioned dimensions of the optical element, it is possible to easily apply it to existing optical surfaces in a space-saving manner. In particular, the optical element can be applied to the optical component in an optically subtle manner. This is particularly advantageous for aesthetic reasons when the optical element is applied to wearable glasses.

According to another embodiment of the invention, each optical element is manufactured by executing the method steps A) to D) of the method according to the invention and/or any of other embodiment of said method.

Preferably, the membranes of the apparatus are held by movable dies. These dies are preferably mounted so that they can be moved linearly by means of a guide means and can be adjusted along a guide axis by means of an adjustment means. Preferably, the membranes are replaceably held by the dies.

Preferably, the apparatus comprises a spacer element, which at least in the second relative position of the membranes are arranged between the membranes or the dies. The spacer element allows a thickness of the optical element to be adjusted in an axial extension and radial extension direction. Preferably, the spacer is replaceably held in the apparatus such that the axial and/or radial extension of the optical element can be adjusted by replacing the spacer.

Preferably, the apparatus has at least one mechanical means for deforming the first and/or second membrane. Preferably, the apparatus has an applicator means by means of which the liquid polymer can be applied to the first or the second membrane in an adjustable amount.

Preferably, the first and/or the second membrane are arranged such that when the curable, liquid material polymer is located between the membranes, a side of the membrane facing away from the polymer can be applied with mechanical force or fluidic pressure in order to deform the membranes.

### EXAMPLES AND FIGURE DESCRIPTION

The advantages achievable with the invention are explained below with reference to examples of embodiments and the figures.

FIG. 1 shows the steps of a method for manufacturing an optical element according to a first embodiment in views a), b1), b2), c), d), e);

FIG. 2 shows the steps of a method for manufacturing an optical element according to a second embodiment in views a), b);

FIG. 3 shows an optical system according to the invention;

FIG. 4 shows an embodiment of manufacturing steps of an optical system according to the invention; and

FIG. 5 shows an embodiment of manufacturing steps of an optical element according to the invention.

For a better understanding of the figures, reference is made to the following list of reference numerals.

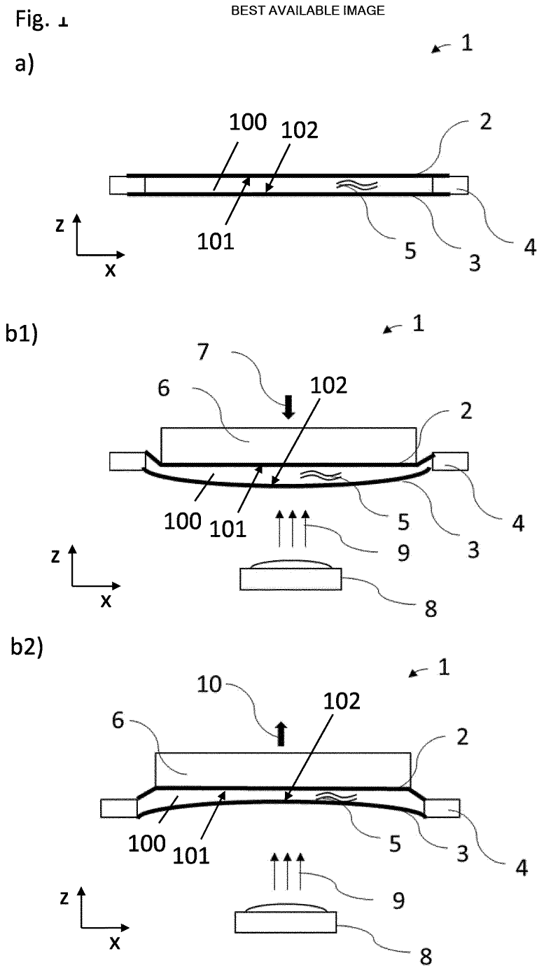

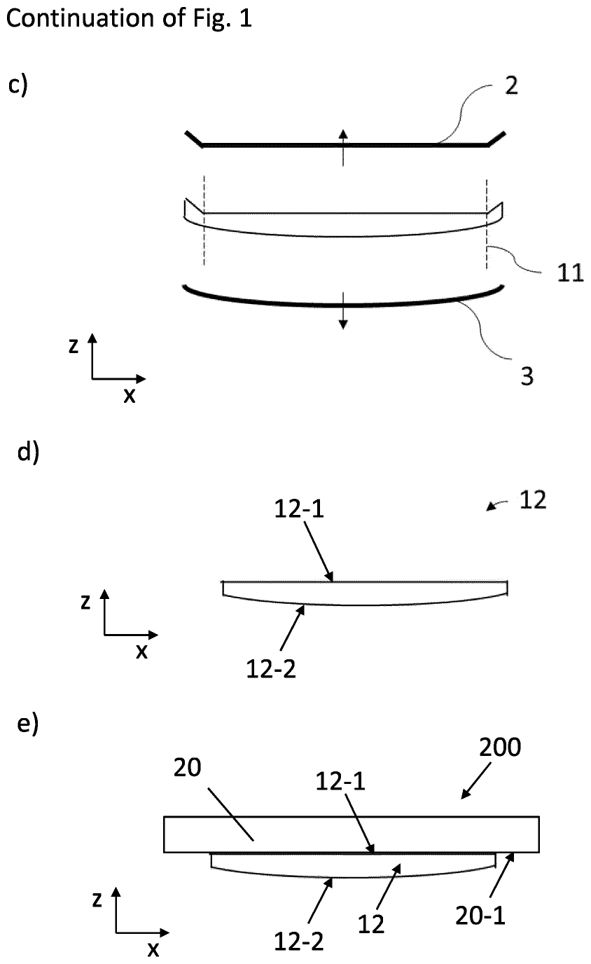

FIG. 1 shows a schematic cross-sectional drawing of an apparatus 1 for manufacturing an optical element 12 in views a), b1), b2), c) and d). The apparatus comprises a first membrane 2 and a second membrane 3 forming a cavity 100 with a first and a second surface portion 101, 102 of the cavity 100. The first and the second membranes 2, 3 are transparent and consist of an elastic polymer. In the following the features and functionalities of the apparatus may relate to the method according to the invention in the same fashion, such that FIG. 1 serves also for illustrating the method and its steps for optically modifying an optical component 20.

As shown in view a) of FIG. 1, the first membrane 2 and the second membrane 3 in a first state of the apparatus 1 both extend along a main extension plane x and are essentially flat. In a manner not shown here, the membranes 2, 3 each have a substantially circular cross-section, which extends into the image plane of FIG. 1.

The membranes 2, 3 are spaced apart by a ring like spacer 4 and together form the cavity 100 filled with a transparent liquid polymer 5. The polymer is a so-called uv-curing polymer 5 that cross-links when exposed to UV radiation, changing from a liquid state to an increasingly solid state. This effect is used to obtain the optical element 12 from the transparent liquid polymer 5.

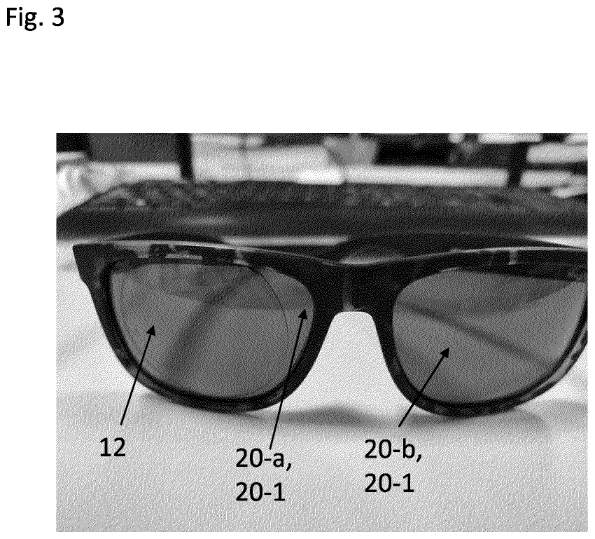

The optical element 12 serves as an applicable element for the optical component 20, to adjust the optical properties of the optical component 20 as required. The optical component 20 may be the lens of a pair of glasses, in particular sunglasses, ski goggles or virtual reality glasses (cf. e.g. FIG. 3).

In order to adjust the optical properties of said optical component 20 as required, the liquid polymer 5 is adjusting a shape of the first membrane 2 and second membrane 3 according to the shape of the desired optical element 12 and its optical properties.

This is shown in views b1) and b2) of FIG. 1, each of which illustrates different ways in which the membranes 2, 3 can be deformed to obtain the shape of the first and the second surface portion 101, 102 of the cavity 100 and thus a first and at second surface 12-1, 12-2 of the optical element 12.

According to view b1) of FIG. 1, a mechanical deformation element 6 is used, which exerts a compressive force 7 on the first membrane 2, thereby deforming it and adjusting its shape.

As a result of the deformation of the first membrane 2, the hydraulic pressure in the polymer 5 increases, causing the second membrane 3 to also deform. In this way, the first 2 and the second membrane 3 can be deformed simultaneously and according to the desired shape.

During or after deformation, the polymer 5 is exposed to ultraviolet radiation 8 from a radiation source 9 through the second membrane 3.

As an alternative to the process shown in view b1) of FIG. 1, according to view b2) the deformation device 6 can also be used to exert a pulling force 10 that is applied to the first membrane 2. As a result of the low pressure thus generated, the second membrane 3 is also deformed, whereby the desired shape of the optical element 12 to be produced can also be adjusted. Here, the deformation means 6 is attached to the first membrane 2 by means of an adhesive.

The curing process shown in views b1) and b2) is controlled depending on the curing state of the polymer and may be terminated before the polymer is fully cured. This can be done in a simple way by controlling the irradiation duration or irradiation intensity, on which the degree of cure depends.

As shown in view c) of FIG. 1, following the curing process, membranes 2 and 3 are removed and the cured polymer is trimmed along cut edges 12.

Subsequently, in view d), the optical element 12 with the first 12-1 and the second surface 12-2 is obtained according to the shape shown in view d) of FIG. 1.

The optical element 12 may be attached to the optical component 20 as shown in FIG. 1e). This may be facilitated by means of Van del Waals forces, particularly only by means of Van der Waals forces. For this purpose, the optical element may be attached or pressed with its first surface 12-1 to an optical surface 20-1 of the optical component 20, such that the optical element 12 and the optical component 20 are in close contact to enable the Van der Waals forces to permanently fix the optical element 12 to the optical component 20.

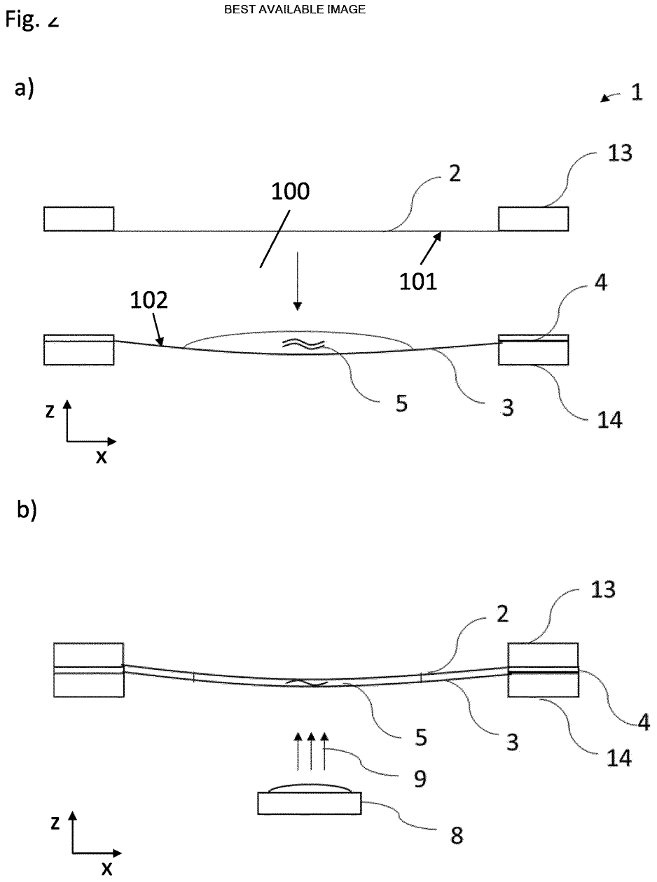

FIG. 2 shows another embodiment of the device 1, which has partly the same components already explained with respect to FIG. 1. For better comprehensibility, the same reference signs are used for the same components and reference is made to the explanations for FIG. 1.

According to FIG. 2, the membranes 2 and 3 are each held at the edge by means of a die 13 and 14, respectively.

The dies 13 and 14 are movable between a first and a second relative position. In the first relative position, which is shown in view a) of FIG. 2, an ultraviolet curable liquid polymer 5 is applied to the second membrane 3.

The second membrane 3 is elastic such that it deforms as a result of the application of the liquid polymer. In particular, the deformation of the second membrane 3 is caused by the weight force of the polymer 5.

Subsequently, the first die 13 is moved in such a way that the first membrane 3 arranged thereon comes into contact with the polymer 5 and deforms substantially in accordance with the second membrane 3 as a result of an adhesion force. This can be seen in view b) of FIG. 2.

In the state shown in view b) of FIG. 2, the polymer 5 can be cured as described in FIG. 1.

The optical element 12, which is manufactured according to the processes illustrated in FIGS. 1 and 2, can have one of its surfaces applied to another optical component (not shown in FIG. 2), in particular by means of a soluble adhesive and/or Van der Waals forces.

FIG. 3 shows an optical component 20 in form of sunglasses having an optical element 12 attached to it on the side of the eyes of a user of the sunglasses (the optical element 12 is particularly visible on its circumference as a dark circular line on the surface portion 20-a). The optical component 20 and the optical element 12 form an optical system 200, wherein the optical element 12 is manufactured to adjust an optical aberration such as cylinder, astigmatism or another higher-order Zernike polynomial describing an optical aberration. This way, the sunglasses 20 that may not exhibit any optical power or aberrational adjustment, may be adjusted in terms of the optical power and the optical aberrations by the optical element 12 to correct for vision deficits of the user in a cost-efficient way.

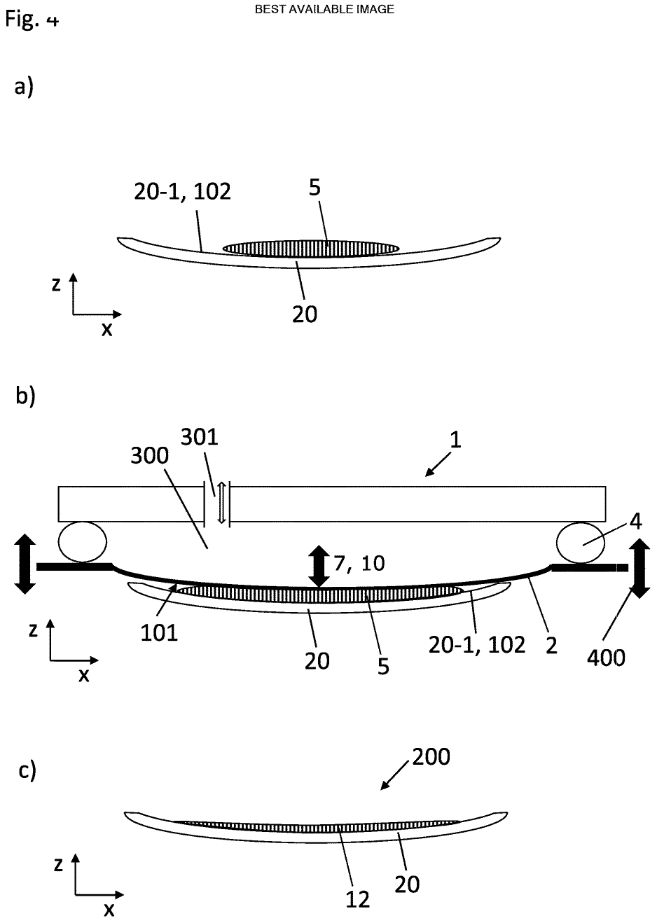

FIG. 4 a) to c) schematically depict an embodiment of the method that employs the optical surface 20-1 of the optical component 20 as the second surface portion 102 of the cavity 100. According to this embodiment the liquid material 5 is directly applied onto the optical surface 20-1 of the optical component 200. In in this case the optical surface is part of a glass of googles. In a next step, shown in FIG. 4b), the first surface portion 101 of the cavity 10 is provided to the liquid material 5 arranged on the optical surface 20-1. As always, the first surface portion corresponds to the first membrane 2.

The first membrane 2 is part of a shaper device 1, wherein the shaper device 1 is configured to adjust a pressure 6 on the side of the first membrane 2 that faces away from the liquid material 5. For this purpose, the shaper device 1 comprises a pressure chamber 300 in which a pressure may be adjusted. In this example the pressure in the pressure chamber 300 may be adjusted by pumping a fluid in or out of the pressure chamber 300 via an opening 301. The pressure chamber may comprise at w all portion spacers 4 that allow for a volume of the pressure chamber 300. The shaper device 1 may be moveably along the z-axis, i.e. along an optical axis of the optical surface 20-1, and in addition it may be moveable along x, y as well as tillable around one, two or three axes.

By moving (cf. arrows 400) the shaper device 1 a direct contact is established between the liquid material 5 and the first membrane 2. Prior to this or after this, the pressure in the pressure chamber 300 may be adjusted such that the membrane 2 deforms the liquid 5, adjusts a volume of the liquid material and shapes a surface of the liquid material 5 on the side facing the first membrane 2.

Once the correct shape of the liquid material 5 is achieved, the liquid material 5 may be solidified.

The shaper device 1 may then be retracted (cf. arrows 400) such that an optical system 200 is provided (cf. FIG. 4c)), having an optical component optically adjusted on its optical surface by means of an optical element.

It is noted that the shaper device 1 may comprise additional shaping elements (not shown) that allow adjusting a shape of the first membrane 2 such as to provide and manufacture a shape of the optical element 12 that adjusts the optical component 20 for higher-order Zernike polynomial optical aberrations as described on previous paragraphs.

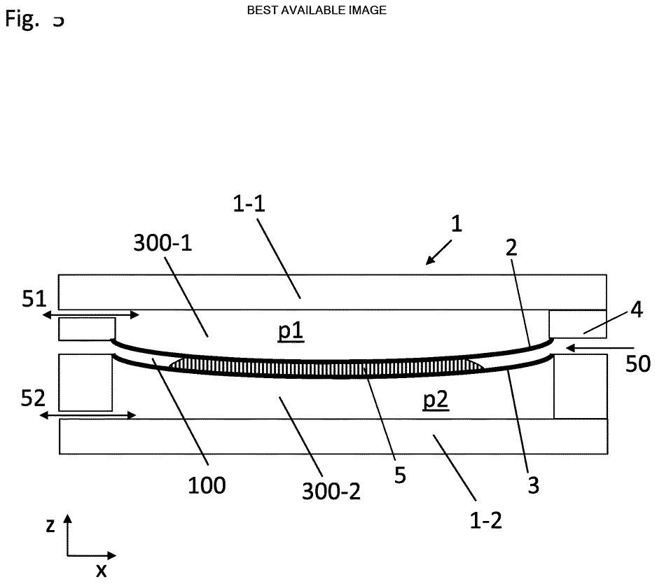

In FIG. 5 another embodiment of the invention is schematically shown. In this example the liquid material 5 is brought between the first and the second membrane 2, 3 into the cavity 5 that is formed between them. For this purpose, the device 1 has an injection opening indicated by the black arrow 50.

Further, the membranes are attached to the device 1, wherein between a particularly transparent top portion 1-1 of the device 1 and the first membrane 2, a first pressure chamber 300-1 is formed that is configured to maintain a pressure p1 of a fluid, such as air. The fluid may be pumped into the first pressure chamber 300-1 through an opening 51 as indicated by a black double-arrow. The device 1 may further comprises a second pressure chamber 300-2 formed between a particularly transparent bottom portion 1-2 of the device 1 and the second membrane 3, wherein also the second pressure chamber 300-2 is configured to maintain a pressure p2 of a fluid, such as air. The fluid may be pumped into the second pressure chamber 300-2 through an opening 52 as indicated by a black double-arrow.

Once, the liquid material 5 is injected into the cavity 100 between the first and the second membrane 2, 3 the first and the second pressure p1, p2, are adjusted such as to shape the first and the second membrane 2, 3. Once the first and the second membrane 2, 3 have adopted the correct and desired shape, the liquid material 5 may be cured in order to fix the shape and thus the optical properties of the optical element 12. For this purpose, it can be advantageous if at least the top or the bottom portion is transparent for the curing wavelength.

In order to accurately tune the shape of the first and the second membrane 2, 3, the first and the second pressure p1, p2 may be adjusted separately by the respective opening 51, 52.

Reference numerals

| | |
|---|---|
| 1 | apparatus |
| 2 | first membrane |
| 3 | second membrane |
| 4 | spacer |
| 5 | transparent liquid polymer |
| 6 | deformation means |
| 7 | pushing force |
| 8 | radiation means |
| 9 | ultraviolet radiation |
| 10 | pulling force |
| 11 | cutting line |
| 12 | optical element |
| 12-1 | first surface |
| 12-2 | second surface |
| 13 | first die |
| 14 | second die |
| z | optical axis |
| x | main extension plane |
| 20 | optical component |
| 20-1 | optical surface |
| 100 | cavity |
| 101 | first surface portion |
| 102 | second surface portion |
| 200 | optical system |
| 300 | pressure chamber |
| 300-1 | first pressure chamber |
| 300-2 | second pressure chamber |
| 301 | opening |
| 400 | Moving directions |
| p1, p2, | pressure |
| 1-1 | top portion |
| 1-2 | bottom portion |
| 50 | opening |
| 51 | opening |
| 52 | opening |

1. A method for optically modifying an optical component with an optical element (12), the method comprising the following steps:
A) Arranging a transparent solidifiable liquid material (5) in a cavity (100), wherein the cavity (100) comprises a first surface portion (101) and a second surface portion (102), wherein the first surface portion (101) of the cavity (100) is formed by a first deformable membrane (2);
B) Adjusting a shape of the first membrane (2), such that an optical power of the optical element (12) to be manufactured is adjusted;
C) Solidifying the liquid material (5) to obtain the optical element (12), wherein the optical element (12) comprises a first surface (12-1) that conforms to the first surface portion (101) of the cavity (100) and a second surface (12-2) that conforms to the second surface portion (102) of the cavity (100), wherein the optical element (12) comprises an optical power adjusted by the shape of the first and the second surface (12-1, 12-2);
D) Attaching the optical element (12) to an optical surface (20-1) of the optical component (20), wherein the first surface (12-1) or the second surface (12-2) of the optical element (12) faces the optical surface (20-1) of the optical component (20), such that the optical component (20) is optically modified by the optical power of the optical element (12).

2. The method according to claim 1, wherein the second surface portion (102) is formed by a second deformable membrane (3), and wherein a shape of the second membrane (3) is adjusted in step B), such as to adjust a shape of the second surface portion (102) of the cavity (100).

3. The method according to claim 1, wherein between step C) and D) the optical element (12) is removed from the second and/or the first surface portions (101, 102) of the cavity (100).

4. The method according to claim 1, wherein the first and/or the second membrane (2, 3) remain attached to the optical element (12), when the optical element is attached to the optical component (20).

5. The method according to claim 1, wherein the first membrane (2) and/or the second membrane (3) is at least partially transparent for ultraviolet radiation (9), and wherein the liquid material (5) is an ultraviolet curing liquid polymer, and wherein method step C) comprises an exposure of the liquid polymer to ultraviolet radiation (9) through the first and/or the second membrane (2, 3).

6. The method according to claim 1, wherein the second surface (12-2) of the optical element (12) is attached to the surface of the optical surface (20-1) of the component (20) by means of Van der Waals forces, particularly only by means of van der Waals forces.

7. The method according to claim 1, wherein the optical element (12), particularly the first and/or the second surface (12-1, 12-2) of the optical element (12) is shaped such that either alone or in combination with the optical component (20) one or more optical parameters selected from the group consisting of cylinder, astigmatism, coma, prism or a higher order Zernike polynomial aberration are adjusted, particularly to adjust a person's vision deficit.

8. The method according to claim 7, wherein the shape of the first membrane (2) and/or the shape of the second membrane (3) is adjusted by a mechanical element (6), wherein the mechanical element (6) is configured to adjust the shape of the first and/or the second membrane (2,3) such as to yield the optical element exhibiting the one or more optical parameters, particularly wherein the mechanical element (6) is a lens shaper device.

9. The method according to claim 8, wherein the shape of the first membrane (2) is formed by the mechanical element (6), and wherein the shape of the second membrane (3) is formed as a function of a hydraulic pressure of the liquid material in the cavity (100) or vice versa.

10. The method according to claim 1, wherein the shape of the first membrane (2) and/or the shape of the second membrane (3) is adjusted by a fluidic pressure that is applied to a surface of the first and/or second membrane (2,3) that faces away from the liquid material (5).

11. The method according to claim 2, wherein the shapes of the first and the second membrane (2, 3) are successive deformation of the first membrane (2) and the second membrane (3).

12. The method according to claim 1, wherein in the liquid material (5) is applied to the first membrane (2) or the second membrane (3) such that the shape of the respective membrane (2, 3) is formed as a result of a force exerted by the application of the liquid material (5), in particular as a result of a force of weight of the liquid material (5) on the respective membrane (2, 3),
and wherein the respective other membrane (3, 2) is brought in contact with the liquid material (5), wherein the shape of the respective other membrane is formed as a result of an adhesive force of the liquid material (5).

13. The method according to claim 1, wherein a solidification, particularly a curing stage of the liquid material (5) is controlled such that the solidified particularly cured optical element (12) is flexible, particularly wherein the solidification is terminated before the liquid material (5) is cured to a solid state, particularly wherein the material comprises a duroplast, an elastomere and/or a thermoplast.

14. The method according to claim 1, wherein the optical component (20) is selected from the group consisting of a rigid lens, ski goggles, scuba diver googles, safety goggles, eyeglasses, sunglasses, virtual reality, augmented glasses, a wave-guide structure, a wave-guide diffractive structure, a wave-guide refractive structure.

15. An optical system (200), comprising a transparent optical element (12) having an optical power, wherein the optical element (12) comprises a material, particularly a polymer, a first surface (12-1) and second surface (12-2) facing in the opposite direction of the first surface (12-2), wherein the optical element (12) is flexible and bendable such that the first surface (12-1) may be bent to conform to a curved surface, wherein the first surface (12-1) is configured such that when the first surface (12-1) is brought in extensive contact with a complementary surface, particularly wherein the surface comprises or consists of a polymer, a synthetic polymer or a glass, Van der Waals forces, particularly only van der Waals forces between the first surface (12-1) and the complementary surface cause the optical element (12) to be attached to the complementary surface, wherein the optical element (12) is shaped such that either alone or in combination with the optical component (20) one or more optical parameters selected from the group consisting of cylinder, astigmatism, coma, prism or a higher-order Zernike polynomial aberration are adjusted, particularly to adjust a person's vision deficit.

16. The optical system (200) according to claim 15, wherein the second surface (12-2) is concave or convex, particularly wherein the second surface is coated by an antireflection coating.

17. The optical system (200) according to claim 15, comprises an optical component (20) with an optical surface (20-1) that comprises the complementary surface, wherein the optical element (12) is attached via its first surface (12-1) to the optical surface (20-1) of the optical component (20) by means of Van der Waals forces, particularly only Van der Waals forces.

18. The optical system (200) according to claim 15, wherein an adhesive is arranged on the first surface (12-1), such that when the optical element (12) is attached to the optical component's optical surface (20-1), the optical element (12) is glued to the optical component (20).

19. The optical system (200) according to claim 15, wherein the optical component (20) is selected from the group consisting of: googles, glasses, VR-googles, wherein the optical surface (20-1) faces towards a person's eyes, when the person wears the optical component (20).

20. The optical system (200) according to claim 15, wherein the optical component (20) comprises two optical surface portions (20-a, 20-b) comprised by the optical surface (20-1), wherein the surface portions (20-a, 20-b) are arranged such that a person wearing the optical component (20) has one of the surface portions (20-a, 20b) arranged in front of the person's eye, wherein on each optical surface portion an optical element (12) is attached.

21. The optical system (200) according to claim 15, wherein the optical power such of each optical element (12) is selected such that an optical power of the optical component (20) is adjusted, particularly wherein the optical power of each optical element (12) is different, particularly wherein the optical component (20) does not exhibit an optical power.

22. The optical system (200) according to claim 15 wherein each optical element (12) is shaped as thin lens, that is adapted to conform with the first surface (12-1) of the optical element (12) the to the optical surface (20-1) of the optical component (20).

23. The optical system (200) according to claim 15, wherein a width of each optical element is at least 5 to 20 times greater, particularly 10 times to 20 times greater, than a thickness of the optical element.

24. An optical system (200), comprising a transparent optical element (12) having an optical power, wherein the optical element (12) comprises a material, particularly a polymer, a first surface (12-1) and second surface (12-2) facing in the opposite direction of the first surface (12-2), wherein the optical element (12) is flexible and bendable such that the first surface (12-1) may be bent to conform to a curved surface, wherein the first surface (12-1) is configured such that when the first surface (12-1) is brought in extensive contact with a complementary surface, particularly wherein the surface comprises or consists of a polymer, a synthetic polymer or a glass, Van der Waals forces, particularly only van der Waals forces between the first surface (12-1) and the complementary surface cause the optical element (12) to be attached to the complementary surface, wherein the optical element (12) is shaped such that either alone or in combination with the optical component (20) one or more optical parameters selected from the group consisting of cylinder, astigmatism, coma, prism or a higher-order Zernike polynomial aberration are adjusted, particularly to adjust a person's vision deficit,
wherein each optical element is manufactured by executing the method steps A) to D) of claim 1.
